(19) United States
(12) Patent Application Publication
(10) Pub. No.: US 2008/0120309 A1
(43) Pub. Date: May 22, 2008

(54) Storing, maintaining and locating information

(75) Inventor: George Prentice Copeland, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/600,974

(22) Filed: Nov. 17, 2006

(51) Int. Cl. G06F 17/00

(52) U.S. Cl. 707/100; 707/E17.045

(57) ABSTRACT

Embodiments are provided to store, maintain, and/or locate information. In an embodiment, historical information can be stored, maintained, and located using a logical schema and a number of temporal tables associated with a database. A number of rules can be used to update information stored in the temporal tables. Query modification rules are provided to allow queries to be readily constructed and can be efficiently executed to search for historical and other information. The embodiments can be used with a number of applications that include objects having associated attributes whose values at different times are of interest.

A portion of the disclosure of this patent document contains material, which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### BACKGROUND

Organizations routinely maintain past and present information associated with members, employees, etc. However, in some instances, the routine maintenance has become mandatory in order to comply with various government regulations (e.g. Sarbanes-Oxley Act, California Senate Bill 1386, the European Privacy Directive, HIPAA). The maintained information can also be used internally in order to gain tighter control over access to certain assets (building access, trade secrets, confidential information, etc.) Thus, it is important for organizations to be able to quickly and efficiently locate and access historical information.

Some organizations use identity and access systems to maintain data, including the information described above. However, gathering and locating information using current identity and access systems can be a cumbersome and inefficient process. For example, some identity and access systems use log and checkpoints to gather historical information. A checkpoint is a snapshot of all data at some point in time. The log and checkpoint strategy requires extra updates (e.g. adding periodic checkpoints) to the log in addition to the normal updates that are required without support for historical information. Also, checkpoints require additional periodic processing, which necessitates extra system management and can impact system availability and throughput. Moreover, searching a log for the state of some object at a specific time (e.g. the nearest checkpoint) can require a significant amount of processing.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided to store, maintain, and/or locate information. In an embodiment, historical information can be stored, maintained, and located using a logical schema and a number of temporal tables associated with a database. A number of rules can be used to update information stored in the number of temporal tables. Query modification rules are provided to allow queries to be readily constructed and can be efficiently executed to search for historical information. The embodiments described herein can be used with a number of applications that include objects having associated attributes whose values at different times are of interest, but are not so limited.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 depicts a block diagram of a computing network.

FIG. 2 is a flow chart depicting a process for maintaining data.

FIG. 3 depicts a block diagram of an information search using a number of predicate constraints.

FIG. 4 is a block diagram illustrating a computing environment for implementation of various embodiments described herein.

### DETAILED DESCRIPTION

Embodiments are provided to store, maintain, and/or locate information. In an embodiment, historical and other information can be stored, maintained, and located using a logical schema and a number of temporal tables. For example, the logical schema can be used in conjunction with the number of temporal tables to store, maintain, and/or locate identity, access, and other information. In one embodiment, the logical schema can be used to organize and determine relevant information (e.g. identity, access, etc.) at a point in time using structured query language (SQL) predicate calculus, thereby allowing an SQL compiler to determine an optimal query plan. A number of rules are used to update information stored in the temporal database. Query modification rules are also provided to allow queries to be quickly constructed that efficiently search for historical and other information using time and/or other constraints.

The embodiments described herein can be used with a number of applications that include objects having associated attributes whose values at different times are of interest, but are not so limited. In an embodiment, an information system includes a database application that includes a logical schema and a number of associated temporal tables. The temporal tables can be populated using the logical schema to include information such as object identification data, attribute data, value data, etc. The number of temporal tables can also include temporal data, such as first and second time values that are included in each table row. In one embodiment, the temporal tables include an “AddTime” and “DeleteTime” in each row. The AddTime refers to the time that a value associated with an attribute was added to the table. The DeleteTime refers to a time when a value was deleted or not deleted, as described below.

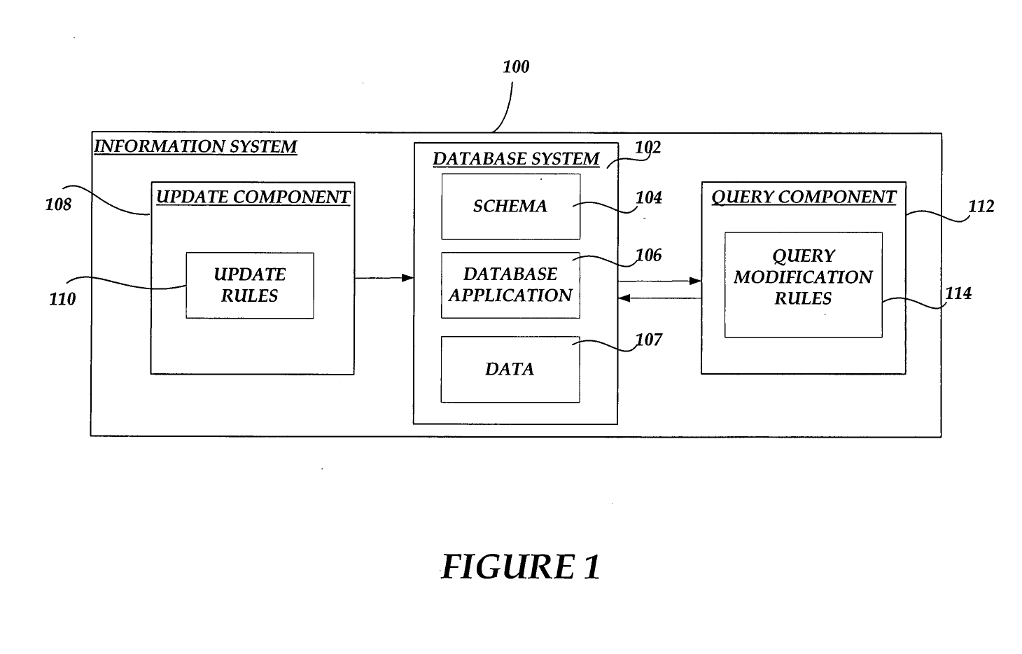

FIG. 1 is a block diagram of an information system 100, according to an embodiment. As described below, components of the information system 100 are configured to store, maintain, and/or locate information, but are not so limited. In one embodiment, the components of the information system 100 can be configured and operated to conduct an audit search to determine identity and/or access information. For example, the information system 100 can comprise an identity integration system for maintaining identity and access information associated with an organization, such as a business enterprise.

For example, an identity and access system can include objects and associated attributes. The objects and associated attributes can include one or more values that are of interest at different times. That is, the identity and access system can include objects that have descriptive information (e.g. name, email, building, phone, etc.) associated therewith. This identity and access system can be configured to store, maintain, and locate information, such as some value at some time for example.

The identity and access system can also include access right information (e.g. remote access, computer/system access, folder access, building entry/access, document access, clearance access, etc.) in the form of one or more attribute values. Each of these attribute values can change over time and their historical values can be of interest. It may be important to know that an employee had access to a resource two months ago, even though the employee no longer has that access. While identity and access systems are used as a context and for examples described herein, the embodiments are not so limited.

With continuing reference to FIG. 1, the information system 100 includes a database system 102. For example, the database system 102 can comprise one or more serving computers and associated storage capacity, such as one or more SQL servers. The database system 102 includes a logical schema 104 and a database application 106. In one embodiment, the logical schema 104 is included as part of the functionality of the database application 106. The logical schema 104 can be used by the database application 106 to store, manage, and/or locate data 107.

The database system 102 also includes information in the form of data 107. In alterative embodiments, the information can be stored and accessed from another location, remote or otherwise. Depending on the particular implementation, the data 107 can include any type and amount of information constrained only by the amount of storage available to the database system 102. For example, the information stored as data 107 may include employee information such as names, e-mail addresses, phone numbers, physical addresses, access data, clearance statuses, title, supervisor, temporal data, etc.

The information system 100 also includes an update component 108. The update component 108 includes a number of update rules 110. The update component 108 and associated rules 110 can be used to update data 107, described below. The information system 100 also includes a query component 112. The query component 112 includes a number of query modification rules 114. The query component 112 and query modification rules 114 can be used when locating data 107, described further below. In alternative embodiments, the various components can be combined and/or configured according to a desired implementation. For example, the update component 108 and/or query component can be included as part of the database system 102. Other embodiments and configurations are available.

As described above, the logical schema 104 can be used to store and/or maintain data 107 of the database system 102, but is not so limited. The logical schema 104 can be used by the database application 106 to store information in the form of data 107 in a number of temporal tables. As described above, the information can include a set of attribute names, along with the type of value and whether it is multivalued. The information can also include a set of object class names, along with the set of attributes it supports and whether each attribute is required. There is a hierarchy of instances, wherein objects own attributes that own values (e.g. objects>attributes>values). Moreover, the hierarchy can be described as a tree structure wherein an object represents the trunk, an attribute represents a branch, and a value represents a leaf.

According to an embodiment, the act of storing data in a temporal table can be streamlined by keeping track of changes to every leaf value. For example, event operations only need to be associated with the leaf level of the hierarchy instead of at each level. Additionally, updating a leaf value can be represented by a delete and add. Thus, add and delete events can be used instead of update, add, and delete events. For example, the logical schema 104 can be used to store identity and access information by giving each attribute value its own row, including an associated AddTime and DeleteTime. Storing add and delete times in the same row with each value simplifies storing and searching/locating since event operations do not have to be stored. Each row can represent all possible events for the value, which includes the add of the value and the delete of the value. Moreover, the organization of the tables allows a time constraint to be easily added to a query, as described by the query modification rules below.

In an embodiment, logical schema for a historical table includes the following columns, shown in Table 1 below.

TABLE 1

| Item | Description |
|---|---|
| ObjectID | The unique identifier of the object |
| AttributeName | The name of the attribute |
| Value | The attribute value (can be multiple columns) |
| AddTime | When the value was added |
| DeleteTime | When the value was deleted. (MaxTime( ) |
| | indicates that the value is current) |

As shown in the example Tables provided below, each individual value can be associated with its own row. The ObjectID is repeated in different rows for each value for the associated object. The AttributeName is repeated in different rows for each value for that attribute. A single-valued attribute for an object can have multiple rows if it changes over time, as shown below. An object's type can be treated as a single-valued required attribute with a special reserved name, “$object_type” for example. In an embodiment, every object has this required attribute and the absence of any rows for an object implies that the object does not exist.

The value can have one or more columns (e.g. ValueString, ValueInteger, ValueBoolean, ValueReference, ValueBinary, etc.), depending on how many attribute types are supported by the database system 102. A column can be provided for each attribute type so that the column can be given an SQL type to enable comparisons for searching. In one embodiment, only one of the value columns is not null. In alternative embodiments, in addition to time or temporal information, other information, such as causation information associated with add and delete events can be included. For example, the information can include a person, rule, or process causing the event (e.g. AddCause and DeleteCause).

As described above, the update component 108 uses the update rules 110 when updating data 107 of the database system 102. In an embodiment, when a new value is added, a new row is inserted in the temporal table with AddTime=CurrentTime( ) and DeleteTime=MaxTime( ). MaxTime( ) is a time that is large enough to never be reached for all practical purposes (e.g. the end of 9999). This is used instead of a null value, so that query time constraints can be simplified as illustrated in the query modification rules described below.

Table 2 below is an example that illustrates adding an object to a temporal table constrained by the above described logical schema. As shown in Table 2, an object is added at time 1 with object type, name, and buildingAccess to building 40. Accordingly, the temporal table include the following rows:

TABLE 2

| ObjectID | AttributeName | Value | AddTime | DeleteTime |
|---|---|---|---|---|
| 100 | $object_type | person | 1 | 9999 |
| 100 | name | Jane Smith | 1 | 9999 |
| 100 | buildingAccess | 40 | 1 | 9999 |

Table 3 below illustrates the temporal table if access is added to building 45 at time 3. Accordingly, the temporal table will include the following rows:

TABLE 3

| ObjectID | AttributeName | Value | AddTime | DeleteTime |
|---|---|---|---|---|
| 100 | $object_type | person | 1 | 9999 |
| 100 | name | Jane Smith | 1 | 9999 |
| 100 | buildingAccess | 40 | 1 | 9999 |
| 100 | buildingAccess | 45 | 3 | 9999 |

As shown in Table 3, a new row has been added to the temporal table to reflect that Jane Smith has been given access to a new building (e.g. building 45) at time 3. Table 4 below illustrates the temporal table when a value associated with an attribute is deleted from the temporal table. When a value is deleted, the associated row is updated with DeleteTime=CurrentTime( ), which is the current date/time for example. Thus, as shown in Table 4, if access to building 45 is taken away at time 5, the temporal table will have the following rows:

TABLE 4

| ObjectID | AttributeName | Value | AddTime | DeleteTime |
|---|---|---|---|---|
| 100 | $object_type | Person | 1 | 9999 |
| 100 | name | Jane Smith | 1 | 9999 |
| 100 | buildingAccess | 40 | 1 | 9999 |
| 100 | buildingAccess | 45 | 3 | 5 |

If a value associated with an attribute is updated, the process includes a combination of a delete operation to delete the old value and an add operation to add the new value. Table 5 below illustrates a name change (e.g. Jane Jones) at time 7. Accordingly, the temporal table will have the following rows:

TABLE 5

| ObjectID | AttributeName | Value | AddTime | DeleteTime |
|---|---|---|---|---|
| 100 | $object_type | person | 1 | 9999 |
| 100 | name | Jane Smith | 1 | 7 |
| 100 | buildingAccess | 40 | 1 | 9999 |
| 100 | buildingAccess | 45 | 3 | 5 |
| 100 | name | Jane Jones | 7 | 9999 |

As shown in Table 5, the update process include a delete of the old name at time 7 and an add operation at time 7. The delete time associated with the new name is set to the maximum value, as described above. Also, note that deleted items are retained in the temporal table, so that the data is available for future queries.

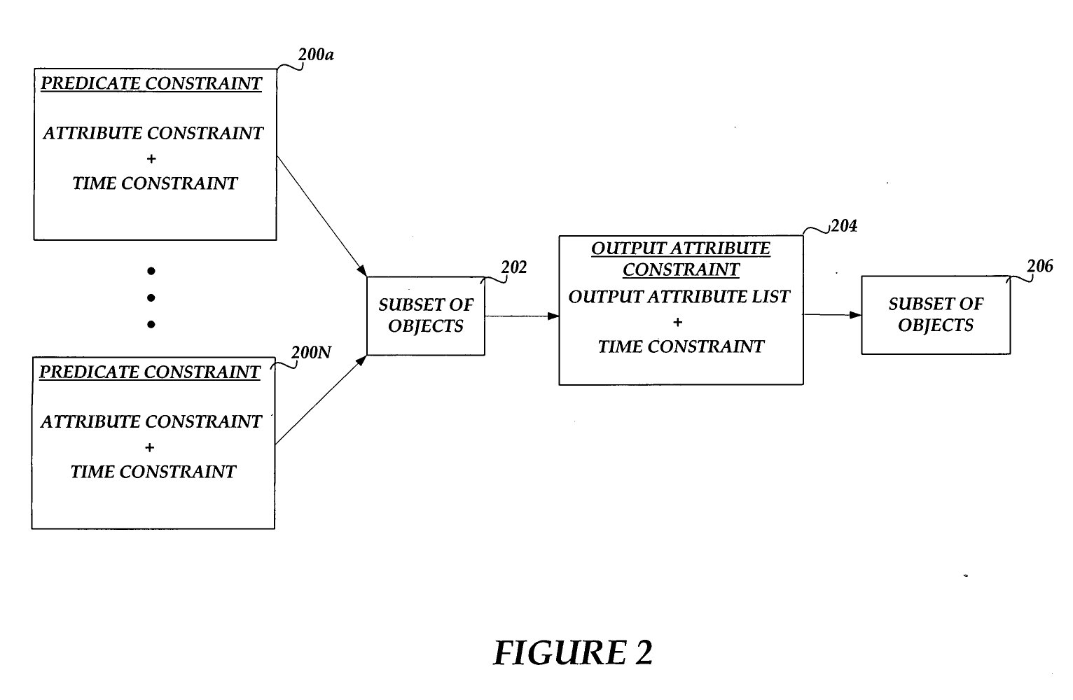

FIG. 2 is a block diagram illustrating aspects of an information search, under an embodiment. As shown in FIG. 2, a number of predicate constraints 200a-200N on attribute values can be used to locate a subset of objects 202. A predicate constraint can be described as a search condition. In one embodiment, each predicate constraint can include an attribute constraint and a time constraint. The set of retrieved attributes can be constrained by an output attribute constraint 204 for these located objects to locate a subset of attributes 206.

The output attribute constraint 204 can include an output attribute list and a time constraint. In an embodiment, a time constraint can be either a time point or a time interval. A time point refers to using values current at that time. A time interval refers to using values current any time during an associated time interval. A different time constraint may be needed for each predicate constraint to determine which objects to select, as well as a time point for the selected attributes of these selected object.

The components of FIG. 1 are referred to in describing the information search. As described above, the query component 112 can use one or more query modification rules 114 when forming queries to locate certain data 107 of the database system 102. A set of predicate constraints can be constructed to determine the set of objects, represented by their ObjectIDs for example. Each predicate constraint can have a different attribute constraint and/or time constraint. The output attribute list is used to limit which attributes are returned for the set of objects. Moreover, the output attribute list can have its own time constraint. A time constraint can be added to each predicate constraint and/or the output attribute list by ANDing in the time constraint.

In an embodiment, there are five basic time constraint types, each having a different SQL modification rule, these include:

1) Current—the where-clause is replaced by “(where-clause) AND DeleteTime=MaxTime( )”.

2) AtTime (For a point-in-time @AtTime)—the where-clause is replaced by “(where-clause) AND @AtTime BETWEEN AddTime AND DeleteTime”.

Alternatively, the where-clause is replaced by “(where-clause) AND AddTime<=@AtTime AND @AtTime<=DeleteTime”.

3) TimeInterval (For a time interval between @StartTime and @EndTime)—the where-clause is replaced by “(where-clause) AND AddTime<=@EndTime AND @StartTime<=DeleteTime” (for two intervals to overlap, the start time for each interval must come before the other's end time).

4) SinceTime (For a special case of a time interval from @SinceTime through now)—the where-clause is replaced by “(where-clause) AND @SinceTime<=DeleteTime”.

5) AllTime (For this special case of a time interval across all time, the where-clause is unchanged).

To illustrate querying the logical schema 104, the following query involves all of the above time constraint types. This query is to find the current email addresses for persons who had access to building 42 on 1/9/2004, had access to building 40 anytime during 2005, and had access to building 45 any time since 1/1/2000.

The query in SQL is:

```
SELECT ValueString FROM AcmeHistory WHERE
ObjectID IN
(
  ( -- AllTime
    SELECT ObjectID FROM AcmeHistory WHERE
    AttributeName = ’objectType’ AND ValueString = ’person’
  )
  INTERSECT
  ( -- AtTime
    SELECT ObjectID FROM AcmeHistory WHERE
    AttributeName = ’buildingAccess’ AND ValueString = ’42’
    AND
    ’1/9/2004’ BETWEEN AddTime AND DeleteTime
  )
  INTERSECT
  ( -- TimeInterval
    SELECT ObjectID FROM AcmeHistory WHERE
    AttributeName = ’buildingAccess’ AND ValueString = ’40’
    AND
    AddTime <= ’12/31/2005’ AND ’1/1/2005’ <= DeleteTime
  )
  INTERSECT
  ( -- SinceTime
    SELECT ObjectID FROM AcmeHistory WHERE
    AttributeName = ’buildingAccess’ AND ValueString = ’40’
    AND
    ’1/1/2000’ <= DeleteTime
  )
)
AND
-- Current
AttributeName = ’mail’
AND
DeleteTime = MaxTime( )
```

In an alternative embodiment, to allow more flexibility in performance tuning, the logical schema 104 may be split into multiple tables. For example, large organizations will most likely have large databases and the update/query rates will be more rigorous, so that performance could become an issue. In one embodiment, the current and deleted rows can be stored in separate tables. A Current table can include values that have DeleteTime=MaxTime( ), including: ObjectID, AttributeName, Value, and AddTime. A Deleted table can include values that have been deleted, including: ObjectID, AttributeName, Value, AddTime, and DeleteTime. Accordingly, the tables can have different indexing, allowing the current table to be used without the burden of a large deletion table. For querying, a view (named Versioned) can be provided whose schema is the above logical schema, hiding the above base table organization for performance tuning:

```
CREATE VIEW Versioned AS
(
  SELECT
    ObjectID,
    AttributeName,
    Value,
    AddTime,
    MaxTime( ) DeleteTime
  FROM Current
)
UNION ALL
(
  SELECT
    ObjectID,
    AttributeName,
    Value,
    AddTime,
    DeleteTime
  FROM Deleted
)
```

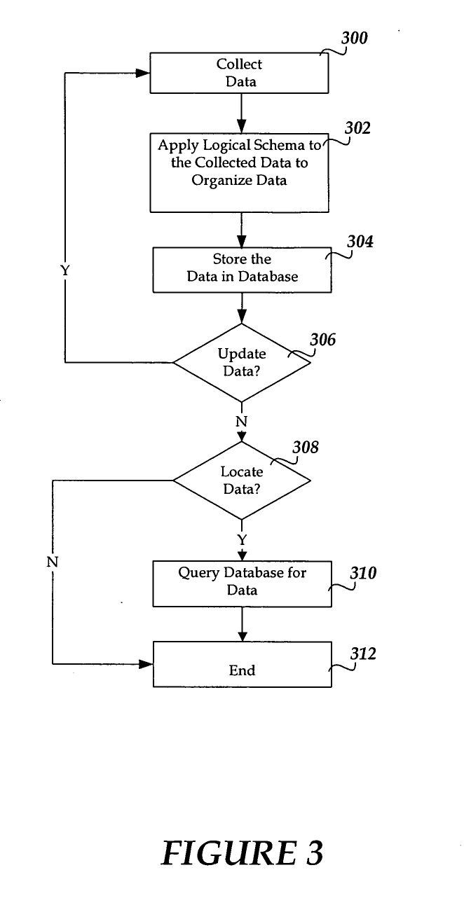

FIG. 3 is a flowchart illustrating a process of storing, maintaining, and locating data in a database. At 300, information and other data is collected. For example, an organization can collect personal information from new hires. The collected information can also include access and other rights associated with the individual. At 302, the database application 106 applies the logical schema 104 to the collected data to organize the data and populate a number of temporal tables, including the AddTime and DeleteTime described above. At 304, the tables and organized data are stored, such as in one or more databases for example.

At 306, it is determined whether records of the temporal table need to be updated. For example, an employee may be given additional rights or rights may be taken away. If updates are required, the flow returns to 300 and the updated data is collected. Otherwise, the flow proceeds to 308 and it is determined whether there is a need to locate certain data. For example, as part of a government requirement, the organization needs to determine what type of access that an employee had on a certain date. Or as further example, the organization needs to know who had access during a certain month when something was stolen or a secret was publicized.

If there is a need to locate data, at 310, the database can be queried as described above to locate the pertinent data. For example, a user interface can be used to input certain search conditions and other constraints to be used in a data search. As an example, the inputs may include the time or period for the constraint, the object and attribute involved, etc. Once all of the inputs are complete, the query component 112 is configured to build and execute the query. In one embodiment, predicate-based calculus as part of the query process in the location of data. Otherwise, if there is no need to locate data, the flow ends at 312.

Embodiments are configured to provide organizations with a unified view of all known identity information about users, applications, network resources, and other data. For example, embodiments assist to increase productivity, reduce security risk, and reduce the total cost of ownership associated with managing and integrating identity information across an enterprise. The embodiments are also configured to allow an organization to integrate user identity information across multiple account stores running on different systems.

### Exemplary Operating Environment

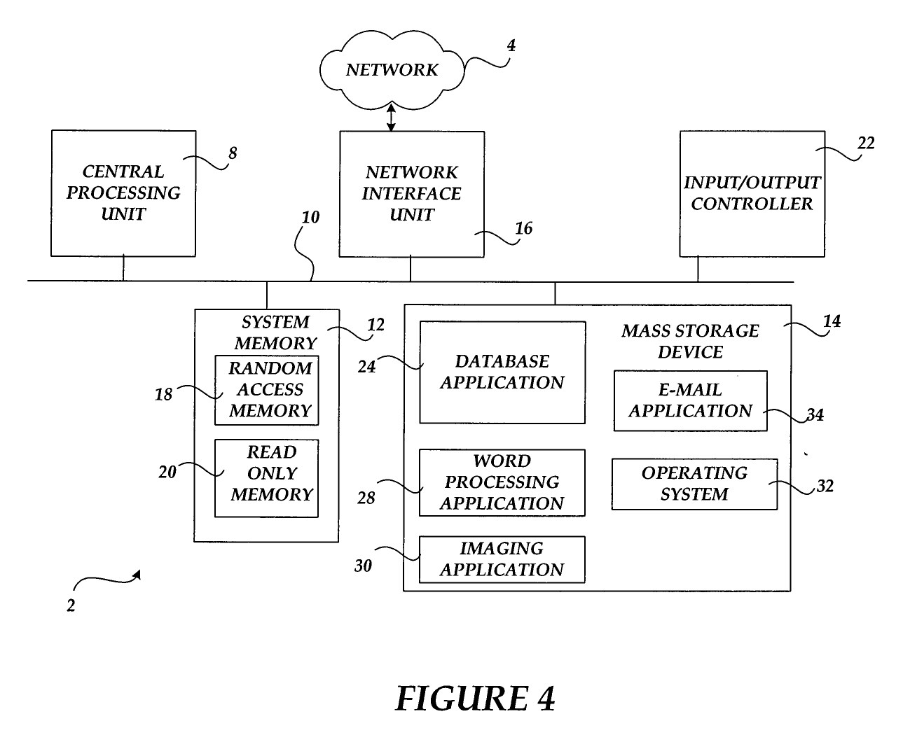

Referring now to FIG. 4, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 4, an illustrative operating environment for embodiments of the invention will be described. As shown in FIG. 4, computer 2 comprises a general purpose desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 32, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 32 suitable for controlling the operation of a networked personal computer, such as the WINDOWS XP operating system from MICROSOFT CORPORATION of Redmond, Washington. The mass storage device 14 and RAM 18 may also store one or more program modules. In particular, the mass storage device 14 and the RAM 18 may store application programs, such as a database application 24, word processing application 28, a spreadsheet application 30, e-mail application 34, drawing application, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A system to manage information comprising:
a database component including a logical schema and at least one temporal table, wherein the temporal table is to be populated based on the logical schema and includes an object identifier, an attribute variable associated with the object identifier, a value associated with the attribute variable, and at least one temporal indicator associated with the value;
an update component to update data stored in the temporal table, wherein the update component includes one or more update rules to update data stored in the temporal table; and
a query component to locate data in the temporal table, wherein the query component includes one or more query modification rules to locate the data.

2. The system of claim 1, wherein the at least one temporal indicator further comprises a first indicator associated with when a value was added to the temporal table, and a second indicator associated with when the value is to be logically deleted from the temporal table.

3. The system of claim 2, wherein the second indicator comprises a maximum time to indicate that the value is current.

4. The system of claim 2, wherein the temporal table further comprises a number of rows, wherein each row of the temporal table includes the first indicator and the second indicator.

5. The system of claim 1, wherein the value can include a chosen set of allowed data types including a string, integer, boolean, reference, and binary.

6. The system of claim 1, wherein the query component is further configured to locate data using structured query language (SQL) predicate calculus.

7. The system of claim 1, wherein the system comprises an identity and access system.

8. The system of claim 1, wherein the logical schema comprises a unique object identification, an attribute name, an attribute value, an add time, and a delete time.

9. The system of claim 1, wherein the temporal table further includes causation information associated with the value.

10. The system of claim 1, wherein the query modification rules comprise a number of time constraint rules for locating data based on a time constraint.

11. A computer readable medium including executable instructions which, when executed, manage data by:
creating at least one database table using a logical schema, wherein the table is associated with a database and includes an object identifier, an attribute variable associated with the object identifier, and a value associated with the attribute variable;
receiving data in the at least one database table; and, indicating when the data is added to the database table by associating a first temporal indicator with the data to indicate when the data was added and associating a second temporal with the data to indicate when the data is to be deleted.

12. The computer-readable medium of claim 11, wherein the instructions, when executed, manage data by indicating when the data is to be deleted by inserting a maximum temporal indicator to indicate a current value.

13. The computer-readable medium of claim 11, wherein the instructions, when executed, manage data by updating the database table using a number of update rules.

14. The computer-readable medium of claim 13, wherein the instructions, when executed, manage data by updating the database table using a delete operation and an add operation.

15. The computer-readable medium of claim 11, wherein the instructions, when executed, manage data by retaining deleted data in the database table.

16. The computer-readable medium of claim 11, wherein the instructions, when executed, manage data by:
collecting identity and access data; and
creating an identity and access database with the collected identity and access data.

17. The computer-readable medium of claim 11, wherein the instructions, when executed, manage data by locating certain data in the database table using query modification rules including a predicate constraint having a time constraint.

18. A method of managing data comprising:
collecting information associated with aspects of an organization;
organizing the information according to a logical schema, wherein the logical schema comprises a unique object identification, an attribute name, an attribute value, an add time, and a delete time; and,
storing the collected information in at least one temporal table, wherein each row of the at least one temporal table includes the object identification, attribute name, attribute value, add time, and delete time.

19. The method of claim 18, further comprising updating identity and access information in the temporal table by using a number of update rules.

20. The method of claim 18, further comprising locating identity and access information in the temporal table using a number of query modification rules, at least one predicate constraint, and a time constraint.
